(19) United States
(12) Patent Application Publication
(10) Pub. No.: US 2010/0070812 A1
(43) Pub. Date: Mar. 18, 2010

(54) AUDIO DATA INTERPOLATING DEVICE AND AUDIO DATA INTERPOLATING METHOD

(75) Inventor: Takanobu MUKAIDE, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/421,508

(22) Filed: Apr. 9, 2009

(30) Foreign Application Priority Data
Sep. 18, 2008 (JP) 2008-239975

(51) Int. Cl. G06F 11/08; G06F 17/17

(52) U.S. Cl. 714/746; 700/94; 708/290; 714/E11.03

(57) ABSTRACT

An audio data interpolating device includes: a reception module configured to receive content data; an extraction module configured to extract first audio data and second audio data corresponding to the first audio data from the content data; an interpolation data detection module configured to detect error data in the first audio data and detect interpolation data corresponding to the error data from the second audio data; and an output module configured to output the first audio data and output the interpolation data in place of the error data included in the first audio data.

### CROSS REFERENCE TO RELATED APPLICATION(S)

The present disclosure relates to the subject matters contained in Japanese Patent Application No. 2008-239975 filed on Sep. 18, 2008, which are incorporated herein by reference in its entirety.

### FIELD

The present invention relates to an audio data interpolating device and an audio data interpolating method for interpolating lost audio data during streaming reproduction of the audio data.

### BACKGROUND

In recent years, the content delivery utilizing the streaming reproduction technology has been started. In such content delivery, a streaming reproducing apparatus reproduces content data while receiving it as it is transferred from a delivery server. This technology makes it possible to start viewing of a content after a short waiting time even if it has a large amount of data.

If an error is detected in content data being transferred from a delivery server, one of the following measures is taken depending on the connection scheme. For example, in the case of the TCP/IP connection, partial data is transmitted again. In the case of the UDP connection, redundant data such as FEC (forward error correction) data is used.

A transmitting apparatus and a receiving apparatus have been proposed which cope with a burst error using such redundant data. In transmitting video data N and audio data n simultaneously, the transmitting apparatus duplicates the audio data n and generates transmission data in which another audio data n having the same content is separated from the original audio data n by a prescribed time or more and sends out the generated transmission data. If detecting damage to one audio data n due to a transmission error, the receiving apparatus performs restoration using the other audio data n. An example of such apparatus is disclosed in JP-A-2005-094661.

However, in the case of coping with an error by retransmission, a transfer of retransmission data lowers the content data transfer efficiency and the probability of occurrence of a buffer underflow in the streaming reproducing apparatus is increased. Once a buffer underflow occurs, the streaming reproducing apparatus suspends the reproduction until a proper amount of reproduction data is stored in the buffer.

In the case of coping with an error using redundant data, it is necessary that both of the delivery server and the streaming reproducing apparatus be able to deal with the redundant data. That is, the delivery server needs to send out content data in which the redundant data is buried and the streaming reproducing apparatus needs to have an ability to correct an error using the redundant data.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 shows a general configuration of a streaming reproducing system according to a first embodiment of the present invention.

FIG. 2 shows a general configuration of a streaming reproducing system according to a second embodiment of the invention.

FIG. 3 illustrates how a time deviation between first audio data and second audio data is detected.

FIG. 4 illustrates example compressed audio output data including re-encoded interpolation data.

FIG. 5 is a flowchart of a first example audio data interpolation process.

FIG. 6 is a flowchart of a second example audio data interpolation process.

FIG. 7 is a flowchart of a third example audio data interpolation process.

### DETAILED DESCRIPTION OF THE EMBODIMENTS

Embodiments of the present invention will be hereinafter described with reference to the drawings.

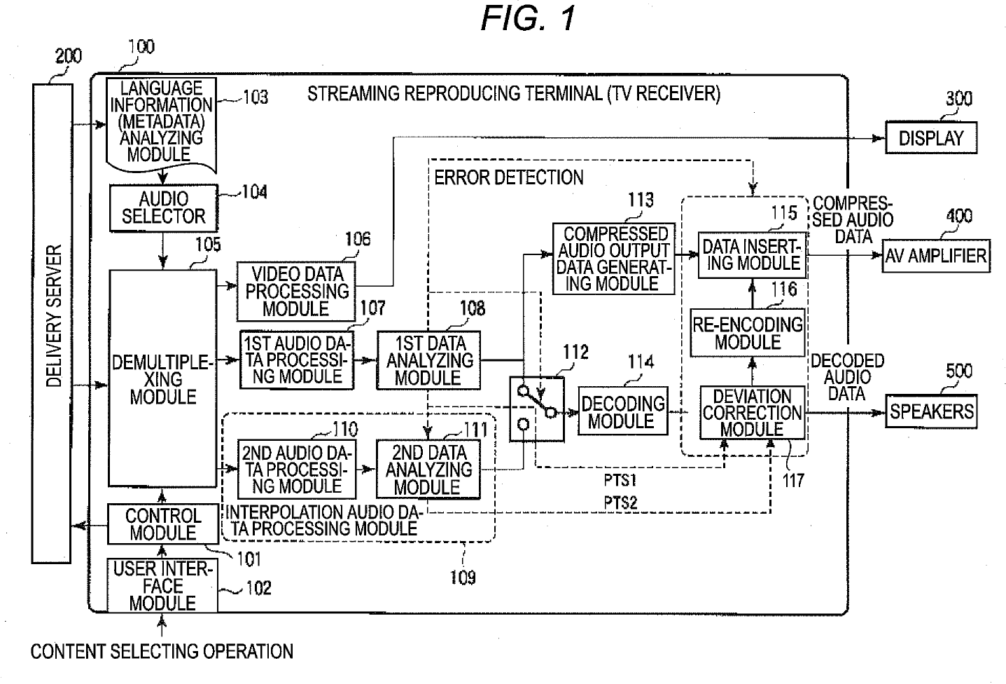

FIG. 1 shows a general configuration of a streaming reproducing system according to a first embodiment of the invention.

For example, as shown in FIG. 1, the streaming reproducing system is composed of a streaming reproducing terminal 100, a delivery server 200, a display 300, an AV amplifier 400, and speakers 500.

The streaming reproducing terminal 100 is equipped with a control module 101, a user interface module 102, a language information analyzing module 103, an audio selector 104, a demultiplexing module 105, a video data processing module 106, a first audio data processing module 107, a first data analyzing module 108, an interpolation audio data processing module 109 (i.e., a second audio data processing module 110 and a second data analyzing module 111), a selector 112, a compressed audio output data generating module 113, a decoding module 114, a data inserting module 115, a re-encoding module 116, and a deviation correction module 117.

The streaming reproducing terminal 100 is connected to the delivery server 200 via a network. That is, the streaming reproducing terminal 100 can receive a video-on-demand service which delivers video/audio contents over the network. For example, a menu picture of the video-on-demand service is displayed on the display 300. The user selects a desired content from the menu picture through the user interface module 102. The user interface module 102 is provided with an operating panel which is attached to a remote controller or the streaming reproducing terminal 100.

The streaming reproducing terminal 100 (control module 101) requests the delivery server 200 to provide the selected content. In response, the delivery server 200 delivers the content to the streaming reproducing terminal 100. Language information (metadata) which is part of content data is input to the language information analyzing module 103. Audio/video stream data of the content data is input to the demultiplexing module 105.

The language information analyzing module 103 supplies an analysis result of the language information to the audio selector 104. The audio selector 104 gives an audio selection instruction to the demultiplexing module 105 on the basis of the analysis result of the language information. For example, assume that the content data includes first audio data and second audio data, the first audio data is audio multiplexed data (2-channel data) including both of Japanese audio data and English audio data and the second audio data is Japanese multi-channel audio data (5.1-channel data). In general, the Japanese audio data included in the first audio data and that included in the second audio data are basically the same audio data through they are different in the number of channels. In this case, the language information includes information indicating that the first audio data is audio multiplexed data including both of Japanese audio data and English audio data and information indicating that the second audio data is Japanese multi-channel audio data.

For example, if the user selects the Japanese data of the audio multiplexed data through the user interface module 102, the control module 101 informs the audio selector 104 of this selection. In response, the audio selector 104 gives the demultiplexing module 105 an instruction to select the Japanese data included in the first audio data. For another example, if the user selects the English data of the audio multiplexed data through the user interface module 102, the control module 101 informs the audio selector 104 of this selection. In response, the audio selector 104 gives the demultiplexing module 105 an instruction to select the English data included in the first audio data. For a further example, if the user selects the Japanese multi-channel audio data through the user interface module 102, the control module 101 informs the audio selector 104 of this selection. In response, the audio selector 104 gives the demultiplexing module 105 an instruction to select the second audio data.

The demultiplexing module 105 receives the audio/video stream data and separates it into video data, first audio data, and second audio data. The separated video data is input to the video data processing module 106. The video data processing module 106 decodes the video data, processes decoded video data according to a resolution etc. of the display 300, and outputs resulting video data to the display 300. The video data is thus displayed on the display 300.

A description will be made of a case that the user has selected the Japanese data of the audio multiplexed data. Separated first audio data (i.e., the Japanese data of the audio multiplexed data) is input to the first audio data processing module 107 and is then input to the first data analyzing module 108 from the first audio data processing module 107. Separated second audio data (the Japanese multi-channel data) is input to the second audio data processing module 110 and then input to the second data analyzing module 111 from the second audio data processing module 110.

If error data in the first audio data is detected, the first data analyzing module 108 sends an error notice to individual modules. If receiving no error notice from the first data analyzing module 108, the selector 112 chooses the first data analyzing module 108 rather than the second data analyzing module 111. That is, the first audio data that is output from the first data analyzing module 108 is input to the decoding module 114. The decoding module 114 decodes the first audio data and outputs decoded first audio data to the speakers 500. As a result, the speakers 500 output the first audio data (the Japanese data of the audio multiplexed data).

The first audio data that is output from the first data analyzing module 108 is also input to the compressed audio output data generating module 113. The compressed audio output data generating module 113 generates compressed audio output data on the basis of the first audio data and outputs it to the AV amplifier 400.

As described above, the streaming reproducing terminal 100 can receive contents that are delivered from the delivery server 200 and reproduce the received contents one by one without storing them in a nonvolatile memory such as an optical disc or an HDD.

Incidentally, if an error is detected in audio/video data that is transferred from the delivery data 200, it is necessary to perform processing for coping with the error. Example measures are to request the delivery server 200 to retransmit partial data or to perform error correction processing.

However, if it is attempted to cope with the error by retransmission, a transfer of retransmission data lowers the content data transfer efficiency and the probability of occurrence of a buffer underflow in the streaming reproducing apparatus side is increased. Once a buffer underflow occurs, the streaming reproduction is suspended, which is uncomfortable to the user.

On the other hand, if it is attempted to cope with the error by error correction processing, it is necessary that both of the delivery server 200 and the streaming reproducing apparatus side have a function of dealing with redundant data for error correction. If one of the delivery server 200 and the streaming reproducing apparatus side is incapable of error correction processing, it is impossible to cope with the error, in which case part of reproduction audio is lost (occurrence of a silent period).

In view of the above, the streaming reproducing terminal 100 independently restores audio data that, for example, has been lost due to an error without requesting retransmission of partial data or performing error correction processing as a measure against the error. To restore audio data, plural audio data (multi-tracks) included in a delivered audio/video content are used. More specifically, second audio data is used when an error occurs during reproduction of first audio data.

In many cases, an error which occurs during streaming reproduction is not such that a large amount of data is damaged but such that only part of certain audio data is damaged among video data and plural audio data. Data interpolation processes according to this embodiment are effective in the case that only part of certain audio data is damaged.

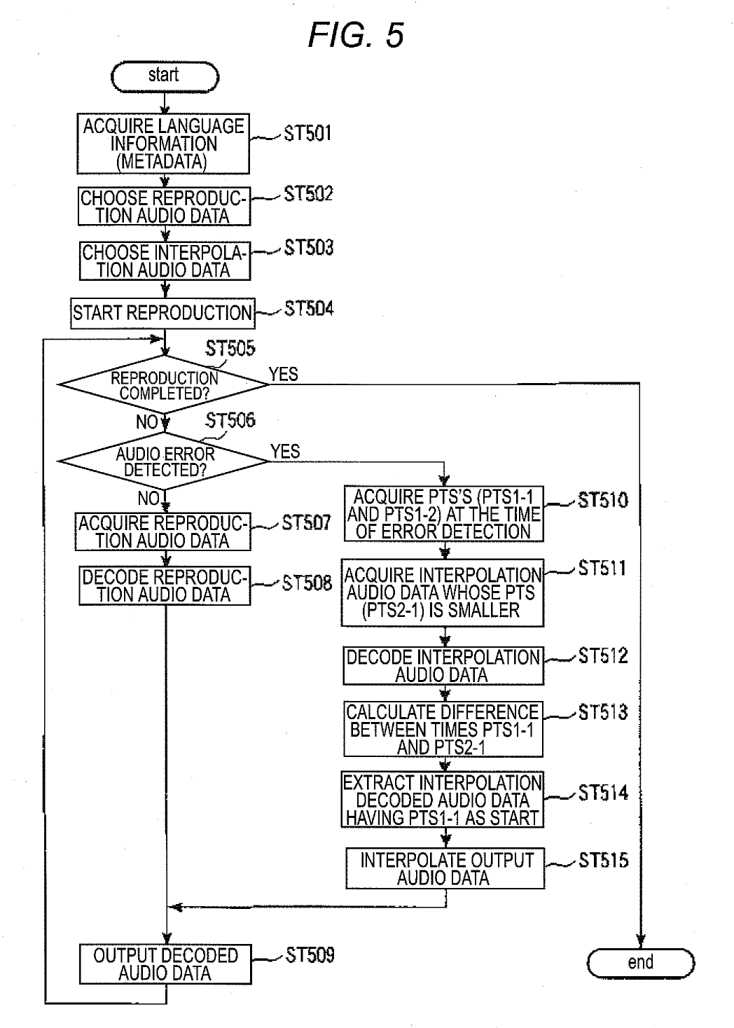

Next, a first example audio data interpolation process will be described with reference to a flowchart of FIG. 5.

At step ST501, as described above, the language information analyzing module 103 acquired language information. On the basis of an analysis result of the language information, the audio selector 104 gives an audio selection instruction to the demultiplexing module 107. The demultiplexing module 107 divides audio/video stream data into video data, first audio data, and second video data, chooses one of the first audio data and second audio data as reproduction audio data at step ST502, and chooses the other as interpolation audio data at step ST503.

For example, if the user has selected Japanese data of audio multiplexed data through the user interface module 102, that is, if the user wants reproduction of the first audio data, the demultiplexing module 107 chooses the first audio data as reproduction audio data and chooses the second audio data as interpolation audio data.

The first audio data chosen as reproduction audio data is input to the first audio data processing module 107 and then input to the first data analyzing module 108 from the first audio data processing module 107, whereupon reproduction is started at step ST504. The second audio data chosen as interpolation audio data is input to the second audio data processing module 110 and then input to the second data analyzing module 111 from the second audio data processing module 110.

If the first data analyzing module 108 detects no error data in the first audio data (ST506: no), at step ST507 the selector 112 inputs the first audio data to the decoding module 114 as reproduction audio data. The decoding module 114 decodes the first audio data at step ST508 and outputs decoded first audio data to the speakers 500 at ST509.

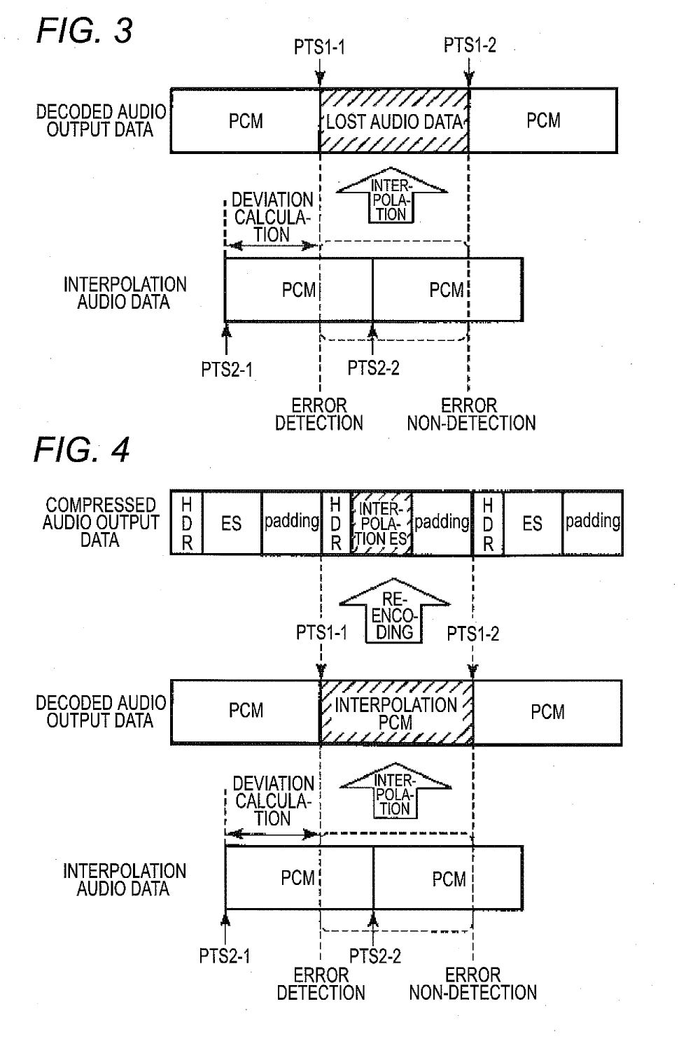

If the first data analyzing module 108 detects error data in the first audio data (ST506: yes), the following audio data interpolation process is executed. As shown in FIG. 3, at step ST510, the first data analyzing module 108 detects an output start time PTS1-1 and an output end time PTS1-2 of the error data of the first audio data and informs the second data analyzing module 111 of an output start time PTS1. During that course, the decoding module 114 continues the decoding and decoded first audio data is accumulated in the deviation correction module 117.

At step ST511, the second analyzing module 111 detects an output start time PTS2-1 which precedes the output start time PTS1-1 from the second audio data (interpolation audio data) and informs the first data analyzing module 108 of the output start time PTS2-1. The first data analyzing module 108 controls the selector 114 so that that portion of the second audio data which ensues the output start time PTS2-1 will be input to the decoding module 114. As a result, at step ST512, the decoding module 114 decodes that portion of the second audio data which ensues the output start time PTS2-1.

The first data analyzing module 108 calculates a time deviation between the first audio data and the second audio data on the basis of the output start times PTS1-1 and PTS2-1 at step ST513, and informs the deviation correction module 117 of the time deviation, the output start time PTS1-1, and the output end time PTS1-2. The first audio data and the second audio data have a time deviation because of a bit rate difference etc. At step ST514, on the basis of the time deviation, the output start time PTS1-1, and the output end time PTS1-2, the deviation correction module 117 extracts interpolation data of the second audio data that corresponds to the error data of the first audio data between the output start time PTS1-1 and the output end time PTS1-2. The deviation correction module 117 inserts the interpolation data in place of the error data of the first audio data at step ST515 and outputs the first audio data at step ST509 in which the interpolation data is interpolated.

On the basis of the time deviation, the output start time PTS1-1, and the output end time PTS1-2, the first data analyzing module 108 controls the selector 114 so that the first audio data is input to the decoding module 114 again after completion of the decoding of the error data. This causes the decoding module 114 to decode the first audio data again.

Next, how to calculate a time difference between first audio data and second audio data will be described in detail with reference to FIG. 3.

First, the following definitions are made.

PTS1-1: Time point when loss of audio data starts (unit: 90 kHz accuracy)

PTS2-1: Time point when interpolation audio data starts and which immediately precedes the time PTS1-1 (unit: 90 kHz accuracy)

fs: Sampling frequency of the interpolation audio data (unit: Hz)

Deviation time ΔPTS=(PTS1-1−PTS2-1)/90,000 (unit: s)

The time ΔT corresponding to the audio data amount N (unit: sample) is given by the following equation:

ΔT=N/fs(unit: s)

Data of N samples that satisfies a relationship ΔPTS=ΔT is discard data. That is, data of N samples starting from the time PTS2-1 of the second audio data is discard data and data ensuing the discard data of the second audio data is interpolation data. Data of N samples can be calculated in the following manner.

N/fs=(PTS1-1−PTS2-1)/90,000

N={(PTS1-1−PTS2-1)/90,000}×fs

A specific example will be described below. If the parameters PTS1-1, PTS2-1, and fs have the following values, data of N samples can be calculated as follows:

PTS1-1=1,960

PTS2-1=1,000

fs=48,000

N={(1,960−1,000)/90,000}×48,000=512

Therefore, PCM audio data of 512 samples starting from the time PTS2-1 is discard data.

With the above operation, even if an error occurs during reproduction of audio data, the streaming reproducing terminal 100 can cope with the error without the need for issuing a data retransmission request or performing error correction processing. That is, even if an error occurs during reproduction of audio data, the streaming reproducing terminal 100 can avoid an event of suspension of the reproduction of content data as well as a silent state due to a lack of audio data while being supplied with the content data stably.

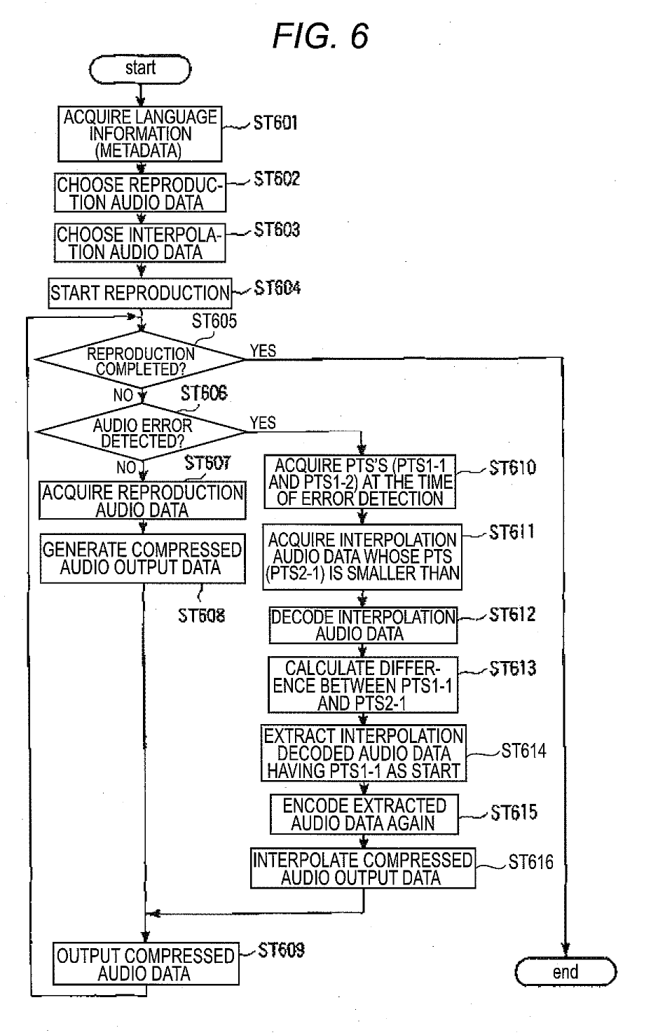

Next, a second example audio data interpolation process will be described with reference to a flowchart of FIG. 6.

In the first example audio data interpolation process, audio data in which interpolation data is interpolated is output to the speakers 500. In contrast, the second example audio data interpolation process is directed to a case that audio data (compressed audio data) in which interpolation data is interpolated is output to the AV amplifier 400.

For example, a description will be made of a case that the user has selected Japanese data of audio multiplexed data through the user interface module 102, that is, the user wants reproduction of first audio data. In this case, the first audio data that has been chosen as reproduction audio data is input to the first audio data processing module 107 and then input to the first data analyzing module 108 from the first audio data processing module 107, whereupon reproduction is started (steps ST601-ST604). Second audio data chosen as interpolation audio data is input to the second audio data processing module 110 and then input to the second data analyzing module 111 from the second audio data processing module 110.

If the first data analyzing module 108 detects no error data in the first audio data (ST606: no), the compressed audio output data generating module 113 generates compressed audio output data from the first audio data at step ST608 and outputs it to the Av amplifier 400 at step S609.

If the first data analyzing module 108 detects error data in the first audio data (ST606: yes), the following audio data interpolation process is executed. As shown in FIG. 4, at step ST610, the first data analyzing module 108 detects an output start time PTS1-1 and an output end time PTS1-2 of the error data of the first audio data and informs the second data analyzing module 111 of an output start time PTS1. During that course, the decoding module 114 continues the decoding and decoded first audio data is accumulated in the deviation correction module 117.

At step ST611, the second analyzing module 111 detects an output start time PTS2-1 which precedes the output start time PTS1-1 from the second audio data (interpolation audio data) and informs the first data analyzing module 108 of the output start time PTS2-1. The first data analyzing module 108 controls the selector 114 so that that portion of the second audio data which ensues the output start time PTS2-1 will be input to the decoding module 114. As a result, at step ST612, the decoding module 114 decodes that portion of the second audio data which ensues the output start time PTS2-1.

The first data analyzing module 108 calculates a time deviation between the first audio data and the second audio data on the basis of the output start times PTS1-1 and PTS2-1 at step ST613, and informs the deviation correction module 117 of the time deviation, the output start time PTS1-1, and the output end time PTS1-2. The first audio data and the second audio data have a time deviation because of a bit rate difference etc. At step ST614, on the basis of the time deviation, the output start time PTS1-1, and the output end time PTS1-2, the deviation correction module 117 extracts interpolation data of the second audio data that corresponds to the error data of the first audio data between the output start time PTS1-1 and the output end time PTS1-2. At step ST615, the re-encoding module 116 encodes the interpolation data. A compression method, a bit rate, and the number of channels of the re-encoding module 116 are the same as those of the compressed audio output data generating module 113.

The data inserting module 115 inserts encoded interpolation data (interpolation ES) in place of the error data of the first audio data (compressed audio output data) at step ST616 and outputs the first audio data (compressed audio output data) in which the encoded interpolation data is interpolated to the AV amplifier 400 at step ST609.

With the above operation, even if an error occurs during reproduction of audio data, the streaming reproducing terminal 100 can cope with the error without the need for issuing a data retransmission request or performing error correction processing. That is, even if an error occurs during reproduction of audio data, the streaming reproducing terminal 100 can avoid an event of suspension of the reproduction of content data as well as a silent state due to a lack of audio data while being supplied with the content data stably.

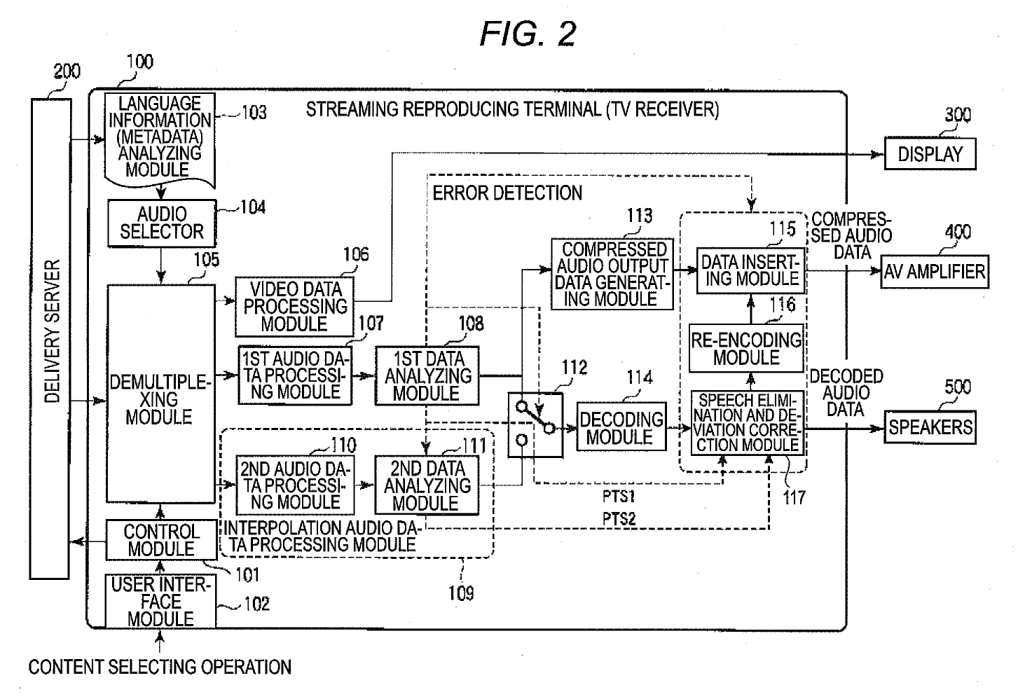

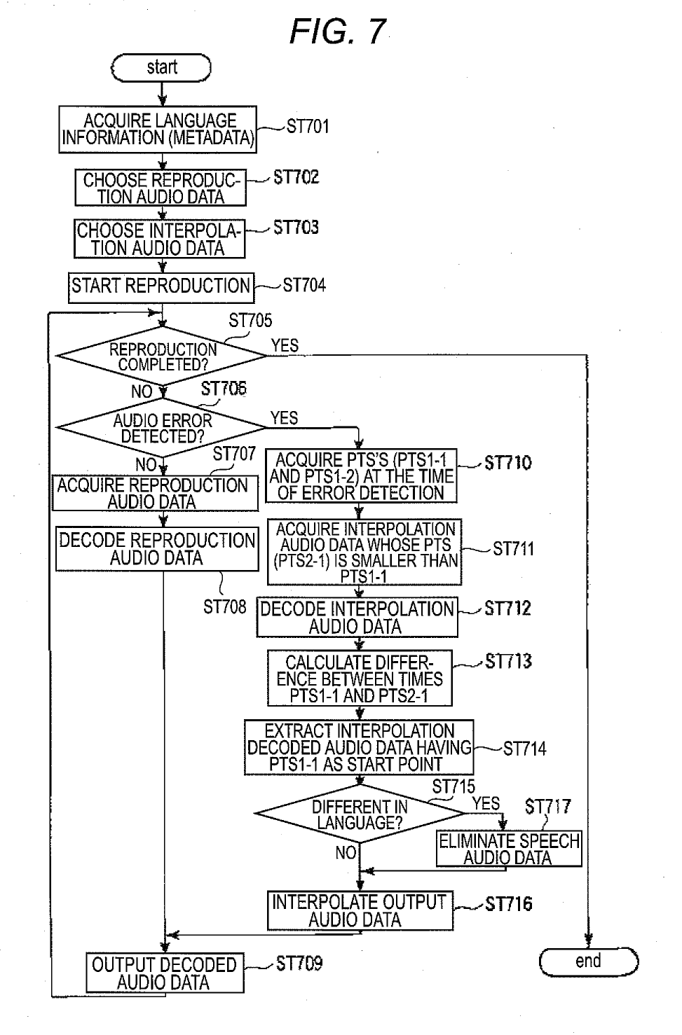

Next, a third example audio data interpolation process will be described with reference to FIGS. 2 and 7. FIG. 2 shows a general configuration of a streaming reproducing system according to a second embodiment of the invention. Whereas the streaming reproducing terminal 100 according to the first embodiment shown in FIG. 1 is equipped with the deviation correction module 117, a streaming reproducing terminal 100 according to the second embodiment shown in FIG. 2 is equipped with a speech elimination and deviation correction module 117′. The streaming reproducing terminal 100 according to the second embodiment is basically the same in configuration as the streaming reproducing terminal 100 according to the first embodiment shown in FIG. 1 except for the above difference and hence will not be described in detail.

FIG. 7 is a flowchart of a third example audio data interpolation process. The first and second audio data interpolation processes were directed to the case that the first audio data was audio multiplexed data including both of Japanese and English audio data, the second audio data was Japanese multi-channel audio data, and the user gave an instruction to reproduce first audio data (Japanese data). Therefore, even if an error occurs in the first audio data (Japanese data), interpolation data was inserted in place of error data using part of the second audio data itself as interpolation data.

The third example audio data interpolation process is directed to a case that the user gives an instruction to reproduce first audio data (English), that is, the language of first audio data to be reproduced is different from that of second audio data for interpolation. In this case, if part of the second audio data itself were used as interpolation data, trouble would occur that switching is made to English audio during reproduction of Japanese audio.

For example, a description will be made of a case that the user has selected English data of audio multiplexed data through the user interface module 102, that is, the user wants reproduction of first audio data (English). In this case, the first audio data that has been chosen as reproduction audio data is input to the first audio data processing module 107 and then input to the first data analyzing module 108 from the first audio data processing module 107, whereupon reproduction is started (steps ST701-ST704). Second audio data chosen as interpolation audio data is input to the second audio data processing module 110 and then input to the second data analyzing module 111 from the second audio data processing module 110.

The first data analyzing module 108 detects reproduction of the first audio data (English) and the second data analyzing module 111 detects reproduction of the second audio data (Japanese). The first data analyzing module 108 instructs the speech elimination and deviation correction module 117′ to eliminate speeches because of the difference in language.

If the first data analyzing module 108 detects no error data in the first audio data (ST706: no), at step ST707 the selector 112 inputs the first audio data to the decoding module 114 as reproduction audio data. The decoding module 114 decodes the first audio data at step ST708 and outputs decoded first audio data to the speakers 500 at ST709.

If the first data analyzing module 108 detects error data in the first audio data (ST706: yes), the following audio data interpolation process is executed. As shown in FIG. 3, at step ST710, the first data analyzing module 108 detects an output start time PTS1-1 and an output end time PTS1-2 of the error data of the first audio data and informs the second data analyzing module 111 of an output start time PTS1. During that course, the decoding module 114 continues the decoding and decoded first audio data is accumulated in the speech elimination and deviation correction module 117.

At step ST711, the second analyzing module 111 detects an output start time PTS2-1 which precedes the output start time PTS1-1 from the second audio data (interpolation audio data) and informs the first data analyzing module 108 of the output start time PTS2-1. The first data analyzing module 108 controls the selector 114 so that that portion of the second audio data which ensues the output start time PTS2-1 will be input to the decoding module 114. As a result, at step ST712, the decoding module 114 decodes that portion of the second audio data which ensues the output start time PTS2-1.

The first data analyzing module 108 calculates a time deviation between the first audio data and the second audio data on the basis of the output start times PTS1-1 and PTS2-1 at step ST713, and informs the speech elimination and deviation correction module 117 of the time deviation, the output start time PTS1-1, and the output end time PTS1-2. At step ST714, on the basis of the time deviation, the output start time PTS1-1, and the output end time PTS1-2, the speech elimination and deviation correction module 117′ extracts interpolation data of the second audio data that corresponds to the error data of the first audio data between the output start time PTS1-1 and the output end time PTS1-2. If the first audio data being reproduced and the second audio data for interpolation are not different from each other in language (ST715: no), the speech elimination and deviation correction module 117′ inserts the interpolation data in place of the error data of the first audio data at step ST516 and outputs the first audio data at step ST709 in which the interpolation data is interpolated.

However, in the example being described, the first audio data (English) being reproduced and the second audio data (Japanese) for interpolation are different from each other in language (ST715: yes). Therefore, the speech elimination and deviation correction module 117′ eliminates speech audio data from the interpolation data at step ST717, inserts speech-eliminated interpolation data in place of the error data of the first audio data at step ST716, and outputs the first audio data at step ST709 in which the speech-eliminated interpolation data is interpolated.

A method for eliminating speech audio data will be described below. For example, the speech elimination and deviation correction module 117′ eliminates audio data to be output to the center channels from the decoding result of the second audio data (Japanese multi-channel audio data) and employs, as interpolation data, audio data to be output to the other channels (i.e., background audio data other than speech data). If the second audio data is not multi-channel audio data, the speech elimination and deviation correction module 117′ eliminates in-phase components (speech data) of the left (L) and right (R) channels from the decoding result of the second audio data and employs, as interpolation data, the remaining audio data (i.e., background audio data other than the speech data).

With the above operation, the streaming reproducing terminal 100 can avoid a lack of audio (silent state) which is uncomfortable to the user even in the case where there are no same-language audio data.

As is understood from the first, second, and third example audio data interpolation processes, the streaming reproducing terminals 100 and 100 make it possible to insert interpolation data in place of error data using the other audio data even if the error data occurs during streaming reproduction of one audio data. That is, the streaming reproducing terminals 100 and 100 can cope with an error without the need for issuing a data retransmission request or performing error correction processing. This makes it possible to avoid suspension of reproduction or a lack of audio (silent state).

Although the above description is directed to the interpolation processes for coping with an error that occurs during reproduction of streaming data that is received over a network, the invention is not limited to such a case. For example, the above-described interpolation processes can cope with an error that occurs during reproduction of a broadcast being received.

The above-described modules may be implemented either by hardware or by software using a CPU or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An audio data interpolating device comprising:
a receiver configured to receive content data;
an extraction module configured to extract first audio data and second audio data corresponding to the first audio data from the content data;
an interpolation data extraction module configured to detect error data in the first audio data and to extract interpolation data corresponding to the error data from the second audio data; and
an output module configured to output the first audio data and output the interpolation data in place of the error data in the first audio data.

2. The device of claim 1, wherein the output module is configured to decode the first audio data and to output the first audio data and configured to decode the interpolation data in place of the error data in the first audio data and to output the interpolation data in place of the error data in the first audio data.

3. The device of claim 2, wherein the output module is configured to encode a decoded version of the interpolation data, to output an encoded version of the first audio data, and to output an encoded version of the interpolation data in place of the error data in the first audio data.

4. The device of claim 1, wherein a language of the first audio data and a language of the second audio data are the same.

5. The device of claim 1, wherein the output module is configured to filter out speech data from the interpolation data if the language of the first audio and the language of the second audio data are different, and to output the filtered interpolation data in place of the error data.

6. A method for interpolating audio data, the method comprising:
receiving content data;
extracting first audio data and second audio data corresponding to the first audio data from the content data;
detecting error data in the first audio data and extracting interpolation data corresponding to the error data from the second audio data; and
outputting the first audio data, and outputting the interpolation data in place of the error data in the first audio data.
